(19) United States
(12) Patent Application Publication
(10) Pub. No.: US 2010/0318741 A1
(43) Pub. Date: Dec. 16, 2010

(54) MULTIPROCESSOR COMPUTER CACHE COHERENCE PROTOCOL

(75) Inventors: Steven L. Scott, Chippewa Falls, WI (US); Gregory J. Faanes, Chippewa Falls, WI (US); Abdulla Bataineh, Eau Claire, WI (US); Michael Bye, Chippewa Falls, WI (US); Gerald A. Schwoerer, Chippewa Falls, WI (US); Dennis C. Abts, Eleva, WI (US)

Correspondence Address: SCHWEGMAN, LUNDBERG & WOESSNER, P.A., P.O. BOX 2938, MINNEAPOLIS, MN, 55402, US

(73) Assignee: Cray Inc., Seattle, WA (US)

(21) Appl. No.: 12/483,915

(22) Filed: Jun. 12, 2009

(51) Int. Cl. G06F 12/08; G06F 12/00

(52) U.S. Cl. 711/122; 711/141; 711/E12.001; 711/E12.026

(57) ABSTRACT

A multiprocessor computer system comprises a processing node having a plurality of processors and a local memory shared among processors in the node. An L1 data cache is local to each of the plurality of processors, and an L2 cache is local to each of the plurality of processors. An L3 cache is local the node but shared among the plurality of processors, and the L3 cache is a subset of data stored in the local memory. The L2 caches are subsets of the L3 cache, and the L1 caches are a subset of the L2 caches in the respective processors.

### FIELD OF THE INVENTION

The invention relates generally to computer cache operation, and more specifically to a computer cache coherence protocol.

### BACKGROUND

Most general purpose computer systems are built around a general-purpose processor, which is typically an integrated circuit operable to perform a wide variety of operations useful for executing a wide variety of software. The processor is able to perform a fixed set of instructions, which collectively are known as the instruction set for the processor. A typical instruction set includes a variety of types of instructions, including arithmetic, logic, and data instructions. The processor receives instructions and data from the computer's memory, and performs the instructions from the computer program in memory using the data elements stored in a data section of the memory.

Because retrieving program instructions and data from memory takes a significant amount of time relative to the time it takes to execute a typical instruction, cache memory is often utilized in high-performance computing systems where fast system speeds require fast and expensive memory to access memory at full speed. The faster a processor operates, the more quickly it must retrieve data and instructions from memory. This requires memory that can be accessed quickly, and due to the very high clock speeds involved, often involves locating the memory in close proximity to the processor. But, fast memory capable of providing data this quickly is expensive, and locating large or custom amounts of memory close to the processor is often impractical. Therefore, one or more separate banks of cache memory, separate from the larger main system memory, are often placed near or on the processor.

This cache memory typically consists of high-speed memory and a cache controller, where the controller has the function of managing what data is copied from the relatively slow main memory into the cache memory based on what data the processor is likely to need soon. The cache memory typically comprises between ten percent and one percent of the total system memory, but may vary over a greater range depending in part on the predictability of the memory access characteristics of the computing system.

In many computer processors and systems, a separate program cache and data cache are employed. The program cache is typically relatively small, and stores the program instructions likely to be executed next. The data cache is typically significantly larger, and stores data that is believed most likely to be used again in the near future, such as data that has been used recently or frequently.

Because successive memory accesses typically occur in a relatively small area of memory addresses, storing the most frequently accessed data in a cache can create significant improvements in system performance. Accessing this most frequently used data at a much faster rate than would be possible if accessing the same data from main memory eliminates forcing the processor to wait while the data is accessed from the slower main memory, and is referred to as a cache hit. If the data the processor needs is not located in cache but must be retrieved from main memory, the request is similarly said to be a cache miss.

The degree to which the cache effectively speeds up memory access can be measured by the number of memory requests that are cache hits and that are cache misses. It is the goal of the cache controller designer to place the data most likely to be needed by the processor in cache, maximizing the ratio of cache hits to cache misses. By employing such a scheme, the system can derive much of the benefit of having a high-speed memory, while reducing overall system cost by storing most data in relatively inexpensive lower-speed memory.

But, various challenges remain for the cache memory architect, including determining how to select what data is stored in the data cache, determining the size and number of caches to employ, and ensuring that various caches and main memory are coherent in that they either all store the current value of the data being used or reflect that the data's true value may have changed and is stored in another part of the memory system.

It is therefore desired to manage cache efficiency and coherence in a high performance computerized system.

### SUMMARY

One example embodiment of the invention comprises a multiprocessor computer system, comprising a processing node having a plurality of processors and a local memory shared among processors in the node. An L1 data cache is local to each of the plurality of processors, and an L2 cache is local to each of the plurality of processors. An L3 cache is local the node but shared among the plurality of processors, and the L3 cache is a subset of data stored in the local memory. The L2 caches are subsets of the L3 cache, and the L1 caches are a subset of the L2 caches in the respective processors.

### BRIEF DESCRIPTION OF THE FIGURES

FIG. 1 shows an example node architecture of a multiprocessor computer system, consistent with an example embodiment of the invention.

### DETAILED DESCRIPTION

In the following detailed description of example embodiments of the invention, reference is made to specific example embodiments of the invention by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit other embodiments of the invention or the invention as a whole, and any reference to the invention, its elements, operation, and application do not limit the invention as a whole but serve only to define these example embodiments. The following detailed description does not, therefore, limit the scope of the invention, which is defined only by the appended claims.

Sophisticated computer systems often use memory architectures that include one or more layers of cache memory, providing a processor with higher speed access to data stored in cache than can be achieved by accessing the same data from main memory. In many such computer systems, multiple layers of cache are used, such as a first level data cache that is a part of the processor itself, and a second level or L2 data cache that is external to the processor. The L2 data cache is typically significantly larger but slower than the first level data cache, but significantly smaller and faster than main memory.

Selection of the speed and size of cache memory, as well as the number of caches to be used, involves tradeoffs between cost, complexity, and performance. Cache memory is typically significantly more expensive than main memory, and so is often limited to a few percent the size of main memory. Similarly, selection of the number of cache levels to employ is dictated by added complexity and cost, performance, and the architecture of the computer system. For example, a multiprocessor computer system having tens or hundreds of processors may well employ traditional level one and L2 caches for each processor, as well as an L3 cache for each processing node or for each processor in the computer system.

A typical cache memory has multiple memory cells with the same shortened address in different banks, where the banks are referred to as ‘ways’. For example, a memory for a system with 16-bit address length may have a 4-way cache, consisting of 4 banks of memory that each have an 8-bit address. When storing data from the main memory in cache, the eight most significant bits of the data main memory address are discarded, and the remaining 8 bits are the cache address into which the data is stored. But, because there are four ways, or banks of memory, with the desired address, the way with the least recently used data is typically chosen as the way into which the data will be stored. This is because it is less likely that the least recently used data will be needed again soon than the more recently used data stored in other ways.

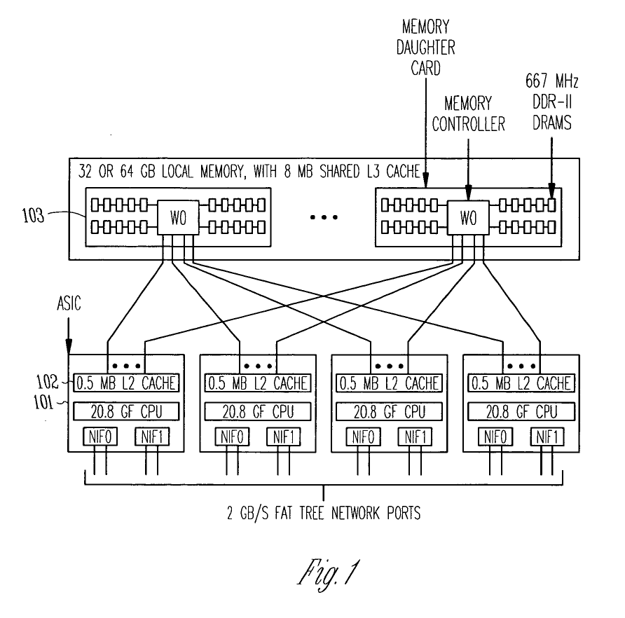

FIG. 1 shows an example node architecture of a multiprocessor computer system, consistent with an example embodiment of the invention. Here, a node comprises four processors 101, each of which contains an L1 scalar data cache (DCache) and a 512 k L2 combined scalar/vector/instruction cache 102. The processors each have connections to 16 local memory daughter cards 103, which together contain 32 or 64 GB of local memory and 8 MB of shared L3 cache.

In this example, each processor 101 has a 16 kB 2-way L1 data cache for scalar data, and a 16 kB 2-way L1 instruction cache for storing program instructions. It also includes a 512 kB 4-way L2 unified cache that is operable to cache both instructions and data, and an 8 MB 16-way L3 cache that is shared by the four processors in the processor node. In this example, the L1 and L2 caches are a part of the processor chip, while the L3 cache is implemented on a memory card that is a part of the processor node. Every entry stored in the L1 cache is also stored in the L2 cache, and every entry in the L2 cache is also stored in the L3 cache.

Caching in this example architecture is limited to caching data within the processor node. Cache coherency is therefore maintained within the processor node, and memory references to memory from another processor node are not cached in the local processor node's cache. The L1 cache is maintained as a subset of the L2 cache, and the L2 cache is maintained as a subset of the L3 cache. Directory entries track the contents of the L2 caches, and backmaps a the L2 track the contents of the L1 data cache.

Certain techniques and structures are provided to increase the performance of partial cacheline read and writes to pending lines, and to provide a more accurate means for the L2 cache to track the contents of the Dcache. The L2 Cache Tag contains a dirty mask for each cache line that keeps track of any word in the cache line that has been written.

If a cache line is waiting to be filled from memory, the cache line is said to be in the pendFill state. Issued reads that hit a line that is in the pendFill state, that have no requests ahead of it in the replay queue, and for which all bits in the mask are included in the dirty mask, are satisfied.

A Vector Store Combining Buffer is a table in each bank which contains the address and mask of speculative vector stores that are waiting for vector data. Vector and scalar loads are allowed to pass vector stores as long as the address is not an exact match and the load request mask and the vector store request masks are mutually exclusive.

The Backmap is responsible for mapping the cache lines from the L2 onto the L1 Dcache. When a line as allocated in the L2 cache, the backmap is updated with the Dcache way that was allocated to that line. Then, if the line is evicted from the L2, the backmap will be used to keep the Dcache consistent with main memory. The backmap provides a more accurate way to track what is truly in the Dcache rather then using inclusion bits as part of the Tag.

All of the caches in the system are kept coherent via hardware state machines. The L1 scalar data caches are managed as write-through to the L2 caches, and therefore never contain dirty data. This allows vector references to hit out of the L2 without interrogating the L1 caches. The L2 caches are managed as writeback caches. The L3 cache implements a directory-based protocol among the four-processor SMP node.

Each of the 32 L2 cache banks on a processor implements its own coherence protocol engine. All requests are sent through the protocol pipeline, and are either serviced immediately, or shunted into a replay queue for later processing. The L2 cache maintains a state, dirty mask, and replay bit for every cache line. The L2 also provides a backmap structure for maintaining L1 Dcache inclusion information. The backmap is able to track the silent evictions from the L1 Dcache.

The dirty mask is cleared when a line is allocated in the cache, and keeps track of all 32-bit words written since allocation. On a write miss allocation, only words not being written by the vector store are fetched from memory. Stride-1 vector stores are thus able to allocate into the L2 and L3 caches without fetching any data from main memory. On writeback events, only dirty 8-byte quantities are written back to the L3 cache, and only dirty 16-byte quantities (the main memory access granularity) are written back to DRAM.

The replay bit indicates a transient line that has one or more matching requests in the replay queue. This is used to prevent a later request from passing an earlier replayed request. Each bank maintains a vector store combining buffer (VSCB) that tracks pending vector write and atomic memory operation (AMO) addresses (including words within the cacheline) that are currently waiting for their vector data. Since the address and data are sent independently to the cache interface, the VSCB is used to combine the store address with its associated data before it is presented to the L2 coherence engine.

A load can read part of a line even though another part of the line is waiting for vector data from a previous store. This prevents inter-iteration dependencies due to false sharing of a cache line. The VSCB allows later vector or scalar loads to bypass earlier vector stores waiting for their data. It also provides ordering with respect to other local requests that arrive after a vector write/AMO but before the corresponding vector data.

Each of the memory controller chips 104 of FIG. 1 contains four subsections, each containing a directory protocol engine, a piece of the local L3 cache containing 128 KB of data, and a memory manager, which handles all memory traffic for the corresponding portion of L3. The directory data structure maintains a simple bit vector sharing set for each of the L2 lines, and tracks whether the lines are shared, or exclusive to an L2 cache (which may have dirtied the line). The memory directory state is integrated with the L3 cache controller state. A global state in the L3 is used to indicate that data is present in L3 and is consistent with main memory although

the data is not cached by any processors. This reduces the number of fill requests to the memory managers for migratory data sharing patterns.

Cache data arrays are protected using a single-bit error correction and double-bit error detection (SECDED) code. If a corrupted line is evicted from the cache, the data is poisoned with a known bad ECC code when the cache data is written back to main memory. Evicting a corrupted cache line will not cause an immediate exception, instead the exception is deferred until the corrupted data is consumed. Three virtual channels (VCs) are necessary to avoid deadlock and provide three-legged cache transactions within the SMP node.

Requests and responses are segregated on VC0 and VC1, respectively. Cache interventions are sent on VC1, and intervention replies travel on VC2. The memory directory is guaranteed to sink any incoming VC2 packet, and is allowed to block incoming requests on VC0 (i.e. no retry nacks are used) while waiting to resolve transient states. Blocked requests are temporarily shunted into replay queues, allowing other, unrelated requests to be serviced. The instruction cache is kept coherent via explicit flushing by software when there is a possibility that the contents are stale.

Although specific embodiments have been illustrated and described herein, it will be appreciated by those of ordinary skill in the art that any arrangement that achieve the same purpose, structure, or function may be substituted for the specific embodiments shown. This application is intended to cover any adaptations or variations of the example embodiments of the invention described herein. It is intended that this invention be limited only by the claims, and the full scope of equivalents thereof.

What is claimed is:

1. A multiprocessor computer system, comprising:
a processing node comprising a plurality of processors and a local memory shared among processors in the node;
an L1 data cache local to each of the plurality of processors;
an L2 cache local to each of the plurality of processors; and
an L3 cache local the node but shared among the plurality of processors;
wherein the L3 cache is a subset of data stored in the local memory, the L2 caches are subsets of the L3 cache, and the L1 caches are a subset of the L2 caches in the respective processors.

2. The multiprocessor computer system of claim 1, further comprising an L1 instruction cache in each of the plurality of processors that is a subset of the respective processors' L2 cache;

3. The multiprocessor computer system of claim 1, wherein cache coherence is only maintained for data stored in the processing node's local memory.

4. The multiprocessor computer system of claim 1, wherein the L2 cache is operable to cache scalar, vector, and instruction data, and the L3 cache is operable to cache scalar, vector, and instruction data.

5. The multiprocessor computer system of claim 1, wherein each of the plurality of processors further comprises an L1 cache backmap indicating inclusion of L2 cache elements in L1 the data cache.

6. The multiprocessor computer system of claim 1, further comprising a vector store combining buffer operable to:
track vector writes waiting for vector data;
combine decoupled vector writes into unified packets including write data; and
present the unified vector write packets to a cache coherence engine.

7. The multiprocessor computer system of claim 6, the vector store combining buffer further operable to present the unified vector write packets to a cache coherence engine

8. The multiprocessor computer system of claim 6, wherein combining decoupled vector writes into unified packets comprises matching matches data and address packets comprising a part of the same write.

9. The multiprocessor computer system of claim 6, wherein vector and scalar loads are allowed to execute before vector stores in the vector store combining buffer as long as an address of the load is not an exact match of a store pending in the vector store combining buffer and the load request mask and the vector store request masks are mutually exclusive.

10. The multiprocessor computer system of claim 6, wherein the vector store combining buffer is further operable to track and combines atomic memory operations.

11. A method of operating a cache in a multiprocessor computer system, comprising:
storing data in an L1 data cache local to a first processor comprising a part of a node, the node further comprising at least one additional processor and a local memory shared among processors in the node;
storing data in an L2 cache local to the first processor; and
storing data in an L3 cache local the node but shared among the first processor and the at least one additional processor;
wherein the L3 cache is a subset of data stored in the local memory, the L2 is a subset of the L3 cache, and the L1 cache is a subset of the L2 cache.

12. The method of operating a cache in a multiprocessor computer system of claim 11, further comprising storing instruction data in an L1 instruction cache in the first processor such that instruction data stored in the L1 instruction cache a subset of instruction data stored in the L2 cache

13. The method of operating a cache in a multiprocessor computer system of claim 11, wherein cache coherence is only maintained for data stored in the processing node's local memory.

14. The method of operating a cache in a multiprocessor computer system of claim 11, wherein the L2 cache is operable to cache scalar, vector, and instruction data, and the L3 cache is operable to cache scalar, vector, and instruction data.

15. The method of operating a cache in a multiprocessor computer system of claim 11, wherein the first processor further comprises an L1 cache backmap indicating inclusion of L2 cache elements in L1 the data cache.

16. The method of operating a cache in a multiprocessor computer system of claim 1, further comprising a operating a vector store combining buffer operable to:
track vector writes waiting for vector data;
combine decoupled vector writes into unified packets including write data; and
present the unified vector write packets to a cache coherence engine.

17. The method of operating a cache in a multiprocessor computer system of claim 16, the vector store combining buffer further operable to present the unified vector write packets to a cache coherence engine

18. The method of operating a cache in a multiprocessor computer system of claim 16, wherein combining decoupled vector writes into unified packets comprises matching matches data and address packets comprising a part of the same write.

19. The method of operating a cache in a multiprocessor computer system of claim 16, wherein vector and scalar loads are allowed to execute before vector stores in the vector store combining buffer as long as an address of the load is not an exact match of a store pending in the vector store combining buffer and the load request mask and the vector store request masks are mutually exclusive.

20. The method of operating a cache in a multiprocessor computer system of claim 16, wherein the vector store combining buffer is further operable to track and combines atomic memory operations.
